(19) United States
(12) Patent Application Publication
(10) Pub. No.: US 2017/0352853 A1
(43) Pub. Date: Dec. 7, 2017

(54) VENT CAP ADAPTOR

(71) Applicant: DOYLE MANUFACTURING, INC., Holland, OH (US)

(72) Inventor: Michael A. Doyle, Holland, OH (US)

(21) Appl. No.: 15/606,171

(22) Filed: May 26, 2017

Related U.S. Application Data
(60) Provisional application No. 62/344,440, filed on Jun. 2, 2016.

(51) Int. Cl. H01M 2/12; H01M 2/04

(52) U.S. Cl. CPC H01M 2/1205; H01M 2/04

(57) ABSTRACT

A vent cap adaptor for coupling a vent cap to a battery cover includes a first portion and a second portion. The first portion is configured to engage the battery cover and the second portion is configured to receive and engage a bayonet-style vent cap. The first portion is annular and the second portion is annular.

### CROSS-REFERENCE TO RELATED PATENT APPLICATION

This patent application claims the benefit of U.S. Provisional Patent Application Ser. No. 62/344,440, filed on Jun. 2, 2016. The entire disclosure of the above patent application is hereby incorporated herein by reference.

### FIELD OF THE INVENTION

The invention relates to batteries, and more particularly to a battery cover assembly including a vent cap adaptor for coupling a vent cap to a vent port of the battery cover.

### BACKGROUND OF THE INVENTION

Many devices use a quarter-turn or bayonet-style attachment in applications where quick installation and removal are desired. For example, lead-acid batteries use this method of attachment for securing the vent caps within the vent ports. The same attachment method is often used in the manufacture of battery watering systems to mount the watering valves to the vent ports.

A typical prior art battery cover assembly for a battery includes a battery vent cap and a battery cover having a vent port. The vent cap and the vent port each include a pair of diametrically opposed bayonet tabs. The tabs have substantially similar lead angles. The individual vent cap is manually tightened within the vent port as the vent cap is rotated 90 degrees clockwise (quarter-turn method) by field personnel. This tightening secures the vent cap and provides a seal between a flange of the vent cap and a rim of the vent port. The seal prevents a migration of battery acid out of the battery. The vent cap can be easily rotated 90° counterclockwise by the user to remove the vent cap from the vent port for routine battery maintenance and inspections.

In certain circumstances, bayonet-style vent caps including flip top caps that address efficiency, environmental, and safety concerns are desired. For example, the WATER MISER® vent cap manufactured by Doyle Manufacturing, Inc. is employed in many assemblies to address the efficiency, environmental, and safety concerns.

The bayonet-style vent caps cooperating with the bayonet-style vent ports are extremely advantageous in provided easy and quick installation and removal of the vent caps. However, many battery cover assemblies include vent caps and vent ports that do not include bayonet tabs for coupling to bayonet-style vent caps. For example, certain battery cover assemblies, for example, include vent caps having external threads engaging with internal threads of the vent port. In another example, the battery cover assemblies includes vents caps engaging with the vent ports by an interference fit or friction fit. These types of battery cover assemblies cannot accommodate bayonet-style vent caps, which may be desired for maximized sealing, easy installation and removal for maintenance and assembly purposes, efficiency, environmental, and/or safety concerns without having to manufacture an entirely new battery cover.

Accordingly, there is a continuing need to produce a vent cap adaptor for coupling bayonet-style vent caps to non-bayonet style battery covers, wherein a cost and inefficiency of manufacturing and assembly is minimized.

### SUMMARY OF THE INVENTION

In concordance and agreement with the present invention, a vent cap adaptor for coupling bayonet-style vent caps to non-bayonet style battery covers, wherein a cost and inefficiency of manufacturing and assembly is minimized, has surprisingly been discovered.

According to an embodiment of the invention, a vent cap adaptor for coupling a vent cap to a battery cover is disclosed. The vent cap adaptor includes. The first portion is configured to engage the battery cover and the second portion is configured to receive and engage a bayonet-style vent cap.

According to another embodiment of the invention, a battery cover assembly is disclosed. The battery cover assembly includes a battery cover including a vent port and a vent cap having a pair of tabs extending outwardly therefrom. The pair of tabs are incompatible for coupling with the vent port of the battery cover. A vent cap adaptor coupled the vent cap to the vent port. the pair of tabs of the vent cap are compatible for coupling with the vent cap adaptor.

According to yet another embodiment of the invention, a battery cover assembly is disclosed. The battery cover assembly includes a battery cover including a vent port having a coupling feature formed on an inner surface thereof.

The battery cover assembly includes a vent cap incompatible for coupling with the vent port of the battery cover. A vent cap adaptor couples the vent cap to the vent port. A first portion of the vent cap adaptor engages the vent port and a second portion of the vent cap adaptor receives the vent cap. The first portion has a coupling feature formed on an outer surface thereof engaging the coupling feature of the vent port.

### BRIEF DESCRIPTION OF THE DRAWINGS

The above objects and advantages of the invention, as well as others, will become readily apparent to those skilled in the art from reading the following detailed description of a preferred embodiment of the invention when considered in the light of the accompanying drawings, in which:

FIG. 1 illustrates a fragmentary assembled top perspective view of a battery cover assembly according to an embodiment of the present disclosure;

FIG. 2 illustrates an enlarged fragmentary partially exploded perspective view of the vent cap assembly of FIG. 1;

FIG. 3 illustrates a top plan view of an adaptor of the vent cap assembly of FIGS. 1-2;

FIG. 4 illustrates a bottom perspective view of an adaptor according to another embodiment of the disclosure; and

FIG. 5 illustrates a top perspective view of an adaptor according to yet another embodiment of the disclosure.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

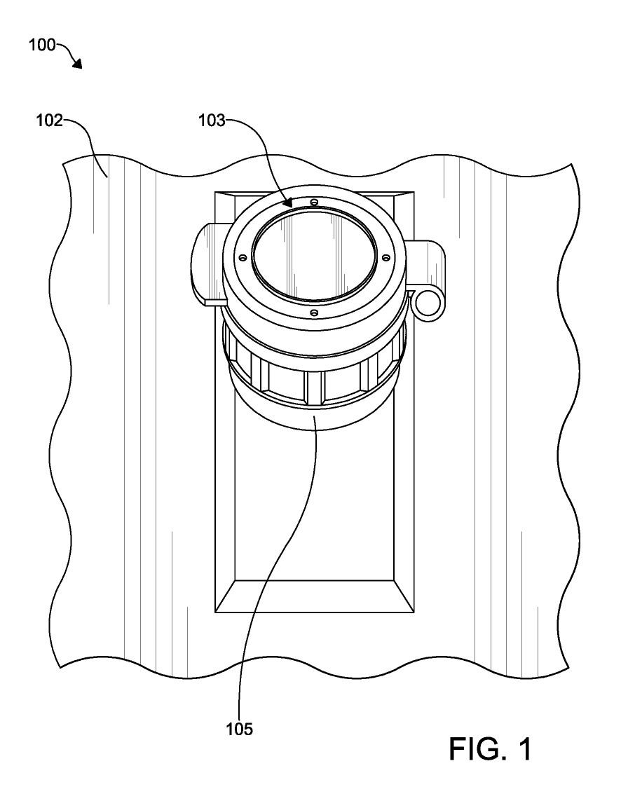

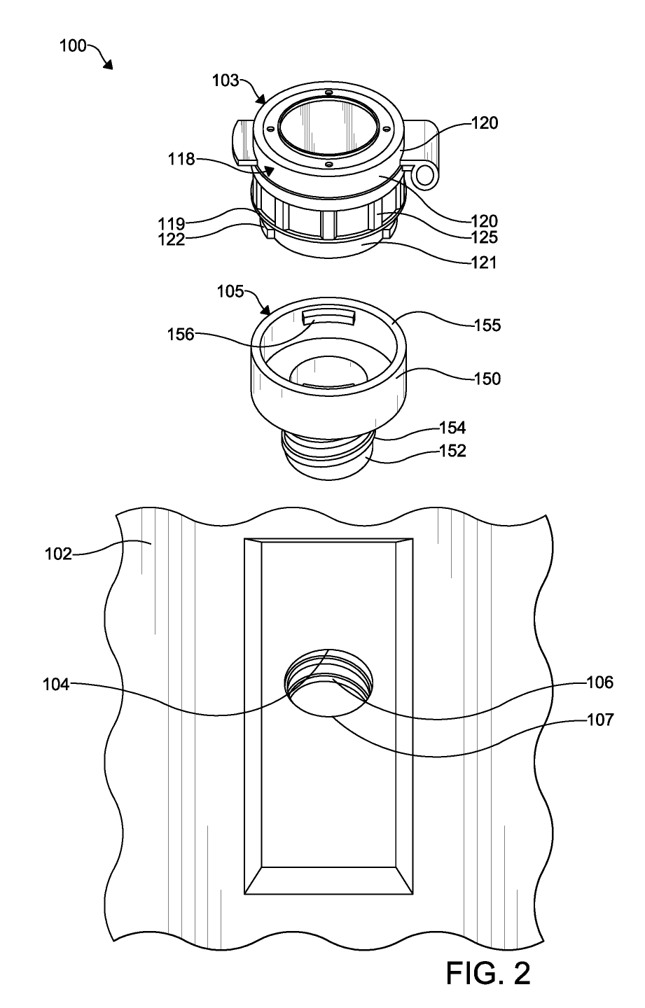

FIGS. 1-2 illustrate a battery cover assembly 100 according to an embodiment of the present invention. The battery cover assembly 100 includes a battery cover 102, a vent cap 103, and a vent cap adaptor 105 coupling the vent cap 103 to the battery cover 102. It is understood that the battery cover 102 can be any suitable battery cover 102 as desired to form a substantially fluid-tight seal with a battery (not shown). The battery cover 102 includes at least one vent port 104 formed therein. In certain embodiments, the battery cover 102 can include a plurality of the vent ports 104 spaced apart from each other. The vent ports 104 can be formed in the battery cover 102 in any pattern or configuration as desired such as in a diagonal configuration or a linear configuration, for example.

The vent port 104 include a rim 107 and a coupling feature 106 formed thereon. The coupling feature 106 can be a non-bayonet style coupling feature such as internal threads, for example. However, it is understood the vent port 104 can include other coupling features such as detents, key slots, or any other coupling feature, as desired. Furthermore, the coupling feature 106 can be bayonet tabs incompatible with the vent cap 103, wherein the vent cap adaptor 105 is required. The coupling feature 106 can also include a smooth inner surface of the vent port 104 configured for interference or friction fit coupling. The battery cover 102 may also include other features and components necessary for operation of the battery such as a pair of terminals and a pair of mounting structures (not shown), for example.

For illustrative purposes, only one vent cap 103 and vent cap adaptor 105 are shown coupled to one of the vent ports 104. But it is understood, additional ones of the vent caps 103 and the vent cap adaptors 105 can be coupled to the battery cover 102 at each of the vent ports 104 where more than one vent port 104 is formed in the battery cover 102. The vent cap 103 and the vent cap adaptor 105 cooperate with the respective vent port 104 formed in the battery cover 102 to couple the vent cap 103 to the vent port 104.

As shown, the vent cap 103 is configured as a bayonet-style vent cap. In the embodiment shown, the vent cap 103 is a flip-top type battery vent cap such as a WATER MISER® vent cap manufactured by Doyle Manufacturing, Inc. However, the vent cap 103 can be any bayonet-style vent cap, as desired. The vent cap 103 includes an annular body 118 and a sealing member 119. It is understood that the body 118 can be formed from any suitable material as desired such as a plastic material, for example.

The body 118 includes an upper portion 120 and a lower portion 121. The upper portion 120 can include a flip-top type lid. In a non-limiting example, the lower portion 121 has a diameter smaller than the upper portion 120. The lower portion 121 has a pair of diametrically opposed, radially outwardly extending bayonet tabs 122. In certain embodiments, the bayonet tabs 122 include a lead angle or are positioned at an angle, other than parallel, to a bottom edge of the vent cap 103 or a bottom surface of a radially outwardly ectending flange 124. In other embodiments, the bayonet tabs 122 are not angled and may include an inclined lower surface and/or an inclined upper surface sloping from the body 118 outwardly from the body 118. Intermediate the upper portion 120 and the lower portion 121 of each body 118 is a radially outwardly extending flange 125. A lower surface of the flange 125 abuts the sealing member 119 which encircles the lower portion 121.

As shown in FIGS. 1-3, the vent cap adaptor 105 includes an annular upper portion 150 and an annular lower portion 152 in fluid communication with the upper portion 150. The lower portion 152 has a diameter smaller than a diameter of the upper portion 150. In a non-limiting example, the lower portion 152 of the vent cap adaptor 105 has a diameter corresponding to a diameter of the vent port 104 of the battery cover 102. The lower portion 152 includes a coupling feature 154 corresponding to the coupling feature 106 of the vent port 104. For example, as illustrated, the coupling feature 154 of the lower portion 152 of the vent cap 103 can be external threads for threaded coupling to the vent port 104 including internal threads as the coupling feature 106 thereof. The vent cap adaptor 105 can be formed from a plastic. In an other example, the vent cap adaptor 105 can be formed from a metal.

The upper portion 150 of the vent cap adaptor 105 includes a rim 155 and a pair of diametrically opposed, radially inwardly extending bayonet tabs 156 formed thereon. In a non-limiting example, at least one of the surfaces of the bayonet tabs 156 of the vent cap adaptor 105 includes a lead angle. In embodiments where the bayonet tabs 122 of the vent cap 103 include a lead angle, the lead angle of the bayonet tabs 156 of the vent cap adaptor 105 correspond to the a lead angle of the bayonet tabs 122 of the vent cap 103.

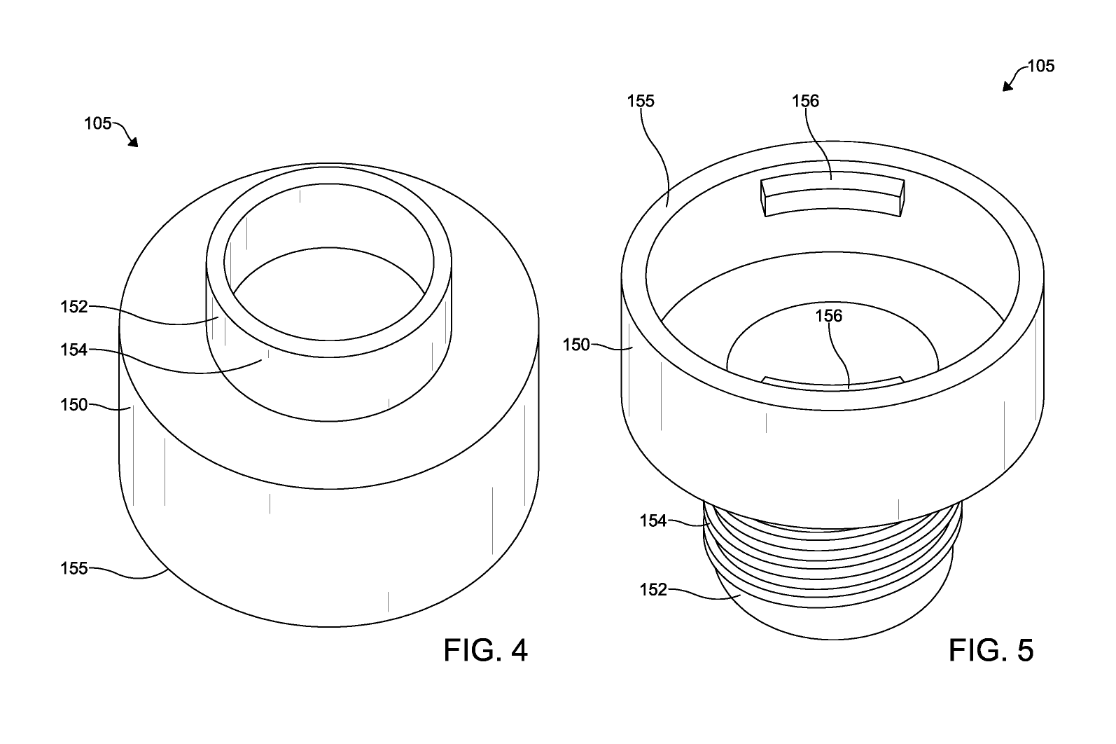

FIG. 4 illustrates a vent cap adaptor 105 according to another embodiment of the disclosure. The same reference numerals used to describe the vent cap adaptor 105 of FIGS. 1-3 are used to describe the vent cap adaptor 105 of FIG. 4. The vent cap adaptor 105 of FIG. 4 is substantially similar to the vent cap adaptor 105 of FIGS. 1-3, except the coupling feature 154 of the lower portion 152 of the vent cap adaptor 105 is a smooth outer surface configured for friction fit coupling to vent port 104 including a smooth inner surface.

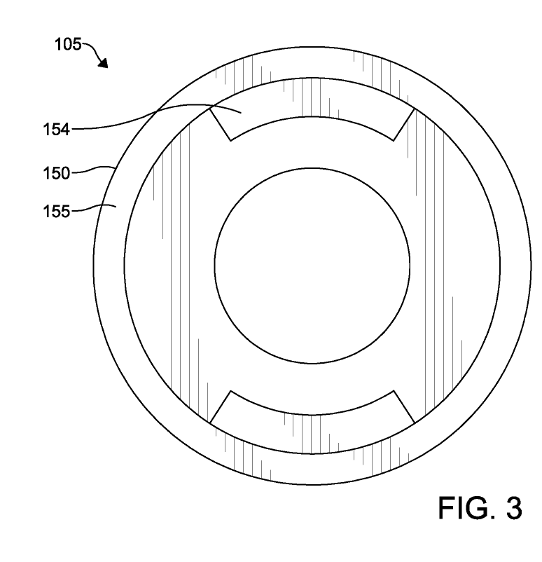

FIG. 5 illustrates a vent cap adaptor 105 according to another embodiment of the disclosure. The same reference numerals used to describe the vent cap adaptor 105 of FIGS. 1-3 are used to describe the vent cap adaptor 105 of FIG. 5. The vent cap adaptor 105 of FIG. 5 is substantially similar to the vent cap adaptor 105 of FIGS. 1-3, except the coupling feature 154 of the lower portion 152 of the vent cap adaptor 105 is external threads with a number of threads and pitch different from the external threads illustrated in FIGS. 2-3.

It is understood the coupling feature 154 of the vent cap adaptor 105 can be any coupling feature as desired compatible with and configured for engaging the coupling feature 106 of the vent port 104. For example, the coupling feature 154 can be features configured for engaging detents, key slots, or any other coupling feature of the vent port 104, as desired.

In application, the vent cap adaptor 105 is configured to couple the vent cap 103 to the battery cover 102. In such an application, the vent cap 103 is incompatible with the vent ports 104 of the battery cover 102, wherein incompatible means the vent cap 103 cannot directly couple to the vent port 104 for its intended purpose to effectively cover and seal the vent port 104.

When installation of the vent cap 103 within the battery cover 102 is desired, the vent cap adaptor 105 is aligned with the vent port 104 of the battery cover 102. The lower portion 152 of the vent cap adaptor 105 is urged downwardly into the vent port 104 and manipulated to engage the coupling feature 154 of the vent cap adaptor 105 with the coupling feature 106 of the vent port 104. When the vent cap adaptor 105 is secured and in an engaged position within the vent port 104, the vent cap 103 is urged downwardly into the upper portion 150 of the vent cap adaptor 105 and manipulated to engage the bayonet tabs 122 of the vent cap 103 with the bayonet tabs 156 of the vent cap adaptor 105. It is understood, the vent cap adaptor 105 can be coupled to the vent cap 103 prior to coupling the vent cap adaptor 105 to the vent port 104.

Advantageously, the vent cap adaptor 105 permits a desired bayonet-style vent cap, or otherwise a vent cap incompatible with the vent port 104, to be coupled to preformed existing battery covers. As a result, new battery covers do not have to be manufactured to conform to the desired vent cap, thus minimizing manufacturing costs and inefficiency.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A vent cap adaptor for coupling a vent cap to a battery cover, comprising:
a first portion configured to engage the battery cover; and
a second portion configured to receive and engage a bayonet-style vent cap.

2. The vent cap adaptor of claim 1, wherein the vent cap adaptor is formed from a plastic.

3. The vent cap adaptor of claim 1, wherein the vent cap adaptor is formed from a metal.

4. The vent cap adaptor of claim 1, wherein the first portion is annular and the second portion is annular, wherein the first portion has a diameter smaller than a diameter of the second portion.

5. The vent cap adaptor of claim 1, wherein the second portion has an inner surface and a pair of radially inwardly extending bayonet tabs formed on the inner surface.

6. The vent cap adaptor of claim 1, wherein the second portion has threads formed on an outer surface thereof configured to engage threads formed on an inner surface of a vent port of the battery cover.

7. The vent cap adaptor of claim 1, wherein the second portion has a smooth outer surface.

8. A battery cover assembly, comprising:
a battery cover including a vent port;
a vent cap having a pair of tabs extending radially outwardly therefrom, the pair of tabs incompatible for coupling with the vent port of the battery cover; and
a vent cap adaptor configured to couple the vent cap to the vent port, the pair of tabs of the vent cap compatible for coupling with the vent cap adaptor.

9. The battery cover assembly of claim 8, wherein the pair of tabs of the vent cap are diametrically disposed from each other.

10. The battery cover assembly of claim 8, wherein the vent cap adaptor includes a pair of diametrically opposed tabs extending radially inwardly from an inner surface thereof.

11. The battery cover assembly of claim 10, wherein the vent cap adaptor includes a first annular portion engaging the vent port and a second annular portion engaging the vent cap.

12. The battery cover assembly of claim 11, wherein the pair of tabs of the vent cap adaptor is formed on an inner surface of the second annular surface and engages the pair of tabs of the vent cap.

13. The battery cover assembly of claim 11, wherein the first annular portion has a diameter smaller than the second annular portion.

14. The battery cover assembly of claim 8, wherein the vent cap adaptor threadingly engages the vent port.

15. The battery cover assembly of claim 8, wherein the vent cap adaptor engages the vent port by a friction fit.

16. The battery cover assembly of claim 8, wherein the vent cap engages the vent cap adaptor with a rotation of about 90 degrees or less and disengages from the vent cap adaptor with a rotation of about 90 degrees.

17. A battery cover assembly, comprising:
a battery cover including a vent port having a coupling feature formed on an inner surface thereof;
a vent cap incompatible for coupling with the vent port of the battery cover; and
a vent cap adaptor coupling the vent cap to the vent port, a first portion of the vent cap adaptor engaging the vent port and a second portion of the vent cap adaptor receiving the vent cap, the first portion having a coupling feature formed on an outer surface thereof engaging the coupling feature of the vent port.

18. The battery cover assembly of claim 17, wherein the coupling feature of the vent port is at least one thread and the coupling feature of the vent cap adaptor is at least one thread corresponding to the thread of the vent port.

19. The battery cover assembly of claim 17, wherein the vent cap adaptor engages the vent port with a friction fit.

20. The battery cover assembly of claim 17, wherein the vent cap includes a pair of diametrically opposed, radially outwardly extending tabs formed on an outer surface thereof engaging a pair of diametrically opposed radially inwardly extending tabs formed on an inner surface of the second portion of the vent cap adaptor.
